(19) United States
(12) Patent Application Publication
(10) Pub. No.: US 2018/0235207 A1
(43) Pub. Date: Aug. 23, 2018

(54) PESTICIDE RETENTION COATING COMPOSITIONS AND USES THEREOF

(71) Applicant: INTEGRICOTE, INC., Pearland, TX (US)

(72) Inventors: Seamus CURRAN, Pearland, TX (US); Kang-Shyang LIAO, Houston, TX (US)

(73) Assignee: INTEGRICOTE, INC., Pearland, TX (US)

(21) Appl. No.: 15/753,374

(22) PCT Filed: Aug. 18, 2016
(86) PCT No.: PCT/US16/47509

§ 371 Date: Feb. 19, 2018

Related U.S. Application Data
(60) Provisional application No. 62/207,750, filed on Aug. 20, 2015.

(51) Int. Cl. A01N 25/04; C09D 5/14; A01N 59/14; A01N 25/24; C09D 7/20

(52) U.S. Cl. CPC A01N 25/04; C09D 5/14; C09D 7/20; A01N 25/24; A01N 59/14

(57) ABSTRACT

Compositions and methods of using the composition to treat substrates in need of a coating compositing to provide protection against pests are described. The coating composition includes at least one pesticide compound and a sol-gel that is derived from least one base compound, at least one bonding agent, and at least one plasticizer. The coating composition is hydrophobic and is capable of penetrating a surface of a substrate in need of coating.

### CROSS REFERENCE TO RELATED APPLICATIONS

This application claims the benefit of priority of U.S. Provisional Patent Application No. 62/207,750, filed Aug. 20, 2015. The contents of the referenced application are incorporated into the present application by reference.

### FIELD OF THE INVENTION

The present invention relates to a hydrophobic coating composition that includes an active ingredient and a sol-gel derived from at least one base compound, at least one bonding agent, and at least one plasticizer, and uses thereof. The coating is capable of penetrating the surface of the substrate and imparts the active ingredient to the inner surface of the substrate. In particular, the hydrophobic coating composition can be used to treat substances to inhibit damage or destruction by pests.

### BACKGROUND OF THE INVENTION

Over the years, much effort has been directed to solving the problem of imparting pest resistance (e.g., insect, fungal and microbial) to wood based products. U.S. Pat. No. 3,945,835 to Clarke et al. and U.S. Pat. No. 4,103,000 to Hartford disclose various aqueous wood treating and/or preservative compositions that contain copper ammonium and/or zinc ammonium cations and arsenic or arsenious anions to make, for example, chromated copper arsenate (CCA) wood treating compositions. While effective at preserving wood, these materials are prone to be leached from the wood by water and the toxic nature of the compositions can create a potential harm to humans and to the environment.

On the other hand, alkaline copper quaternary (ACQ) is a water based wood preservative method recently introduced in countries where there is a demand for alternatives to CCA. U.S. Pat. No. 7,993,756 to Jin et al. described impregnating wood and wood products with a long-chain quaternary ammonium copper compound which is effective to reduce the preservative active ingredient loss in the treated wood or to increase the resistance of the wood to decay. However, the potential of copper leaching can still post a problem for humans (e.g., as contaminants in drinking water) and the environment. In addition, the ACQ can accelerate corrosion of metal fasteners relative to untreated wood, therefore, galvanized copper or stainless steel fasteners must be used for the ACQ treated product.

The use of boron-based formulation for wood preservation has been extensively investigated because of the low acute oral and dermal toxicity of these compounds, as well as their ability to render wood non-flammable when applied with high concentration. Zinc borate hydrate, boric oxide, boric acid, sodium borate, and disodium octaborate tetrahydrate have become popular compounds for treating wood because of their ability to render wood resistant to decay from fungi, termites, wood boring beetles, and general household pests such as cockroaches and silverfish. However, due to the very high solubility of these borate compounds in water, they are easily leached from the treated wood by environmental water and moisture. Therefore, the uses of boron-based treatments are generally limited to indoor use.

To reduce the leachability of boron-based preservatives form the wood based products, U.S. Pat. No. 6,821,631 to Grantham et al. describes steps of applying an alkali silicate aqueous solution followed by applying an alkali borate aqueous solution to wood substrates. U.S. Pat. No. 7,470,313 to Lenox et al. describes methods of applying to wood substrates with an aqueous preservative composition containing a boron compound, a source of zinc, an aqueous silicate, a source of alkalinity, and an amino acid. U.S. Pat. No. 7,497,900 to Hu et al. describes methods of applying to wood substrates with an aqueous composition containing a boron compound, a source of zinc, and ammonia, followed by application of a second aqueous composition containing an alkali metal silicate. U.S. Pat. No. 7,658,972 to Matsumura et al. describes a silicone emulsion composition for wood treatment prepared by emulsifying and dispersing silicone ingredients with a boron compound in water. All of the above publications have showed moderate reduction of leachability of the boron compounds from wood substrates. However, it is expected that the resulted boron preservatives in wood substrates are still prone to leaching by environmental water and moisture because the treatment solutions are all water-based.

It is possible to impregnate boron compounds into wood substrate by other means instead of aqueous based solutions. U.S. Pat. No. 3,342,629 to Martin et al. describes partially moist wood, preferably near its fiber saturation point, being impregnated with a trialkyl borate such as trimethyl borate. The wood is treated by permitting the trialkyl borate to soak into the wood to a suitable depth preferably under pressure. The trialkyl borates are volatile liquids which react with water to form boric acid and release the corresponding alcohol. U.S. Pat. No. 4,354,316 to Schroeder described a wood treatment with an agent capable of forming a borate ester linkage between hydroxyl groups of the cell wall constituents of the wood, such as boric acid or lower polyalkyl borate esters (trimethyl borate or triethyl borate) and thereafter treating the wood with an aldehyde to effect aldehyde crosslinking of cell wall structural constituents of the wood.

The presence of microbes and fouling organisms (e.g., algae, barnacles, tube worms, mussels, etc.) in various coating systems such as paint, stain, sealant, varnish, and finish for building materials for outdoor and aquatic structures such as bridge, pier, offshore platform, swimming pool, aquatic vessels, and the like, can cause deterioration or disfigurement of these systems. For example, painted surfaces may be disfigured by the unsightly buildup of microbes and fouling organisms, thus losing from the overall aesthetics of the painted article. Larger biofouling agents such as Cirripedia cemented to the exterior hulls of aquatic vessels have been shown to increase hydrodynamic drag and/or incite premature structural oxidation, which decrease commerce time, increase fuel/energy consumption, and significantly increase vessel maintenance costs. Conventional practices which inhibit the microbial deterioration of such systems usually incorporate a variety of additives that are characterized by having antimicrobial activity. A wide variety of materials have been used to control microbes in different environments such as bromine/chlorine compounds, copper salts, glutaraldehyde, isothiazolones, organotin formulations, quaternary ammonium compounds and triazines (see, for example, U.S. Pat. No. 4,098,971 to Phillip et al., U.S. Pat. No. 4,253,877 to Miale et al., U.S. Pat. No. 5,110,822 to Sherba et al., and U.S. Pat. No. 6,365,066 to Podszun et al. and U.S. Pat. No. 8,372,384 to Chisholm et al.).

Customary antimicrobial and antifouling coating comprised biocides which kill the infestation-forming organisms are organotin and other heavy metal (e.g., Ag, As, Bi, Cu, Cr, Sb, Pb, etc.) compounds. Biocides contain heavy metals are problematic as they cause contamination of the sea water and of the sea bed, especially in the area of harbors. In contrast to these heavy metal based biocides, heavy-metal-free biocides have generally lower ecotoxicity, as they can frequently be broken down into non-toxic metabolites in case they leach out of the coating and into sea water, therefore do not cause a long-term contamination. However, the active substance can also be degraded prematurely while still inside the coating.

U.S. Patent Application Publication Nos. 2015/0054340, 2014/0342098, and 2013/0337226 to Curran et al., the contents of which are incorporated herein by reference, describe solutions of self-cleaning and/or waterproof coatings and apparatuses for application. The resulting surface prevented the water from “wetting” the substrate (thus becomes “waterproof”) and protected the substrate from the consequences (e.g., stain from dyes/pigments or water damage) caused by the wetting. The solution can include one or more functional additives that can be added into the hydrophobic coating in combination with other functional additives to alleviate damage from weathering (caused by both natural-/artificial-radiation and moisture) or prevent fungal or microbial growth (caused by the fungi, microbes or other microorganisms and moisture).

### SUMMARY OF THE INVENTION

A discovery has been made that solves the problems associated with addition of active materials, in particular, pesticides to a substrate. The premise of the discovery lies in the ability to impregnate the substrate with a coating composition that includes an active compound of the present invention, in addition to coating the surface of the substrate. The active compound can be a pesticide, and, thus, the coating composition can provide protection against pests such as insects (e.g., termites), fungi, microbes, and/or fouling organisms. After drying/curing, the compounds used for the coating form an impenetrable hydrophobic layer and thus provide resistance against leaching of the pesticides from substrates by water in exposed environments such as exterior applications. The coating composition can be impregnated into wood, textiles, masonry materials, or aquatic structures, applied to the soil as barrier treatment, or incorporated into baits for pests. Without wishing to be bound by theory, it is believed that the components of the coating composition act as a carrier for the pesticide, which enables deposition of the pesticide on the outer and/or inner surface of the substrate. The carrier can be a sol or sol-gel. It is further believed that the active compound (e.g., a pesticide) can chemically react with the sol or sol-gel (e.g., formation of a covalent bond) and/or be physically encapsulated in sol or sol-gel network.

The present invention can also provide an effective and elegant antimicrobial and antifouling coating which use low ecotoxicity biocides, but prevent/reduce prematurely leaching to maintain good long term biocidal action. In this invention, fouling resistance may be achieved via the inclusion of one or more biocides that are either target-specific or more general in the particular mechanism of action by which they inhibit or aid in the removal of biofouling agents. In consideration of the diversity of fouling mechanisms of biofouling agents, the specific mechanism of action by which a particular biocide functions is pertinent to achieving the desired antifouling effect. One or more biocidal agents may be included in an antifouling formulation via a number of chemical routes including but not limited to direct covalent linkages or entrapment/encapsulation schemes intended to immobilize the biocidal reagent(s) in a solid-state matrix to varying extents.

Embodiments of the present invention relate to compositions and methods for making coating compositions for substrates. In a particular aspect of the invention, a hydrophobic coating composition capable of resisting pests is described. The hydrophobic coating composition can include at least one active compound (e.g., a pesticide) and a sol-gel derived from at least one base compound, at least one bonding agent, and at least one plasticizer. The coating composition is capable of providing the active component to an inner surface of the substrate (e.g., the active component is distributed throughout the substrate). The pesticide can include an algaecide, an antifouling agent, an antimicrobial, a biocide, a fungicide, a herbicide, an insecticide, a miticide, a molluscicide, a nematicide, a ovicide, a pheromone, a rodenticide or any combination thereof. In a particular aspect of the invention, the pesticide can include a boron compound, a quaternary ammonium salt, or both. Boron compounds which can be used in the present invention include an inorganic borate, an organic borate, or both, preferably, a metal borate, a borate mineral, a borate ester, more preferably a sodium borate compound (e.g., the sodium borate is disodium octaborate tetrahydrate, sodium tetraborate decahydrate, sodium tetraborate pentahydrate, sodium tetraborate, sodium metaborate, sodium pentaborate, and mixtures of any of the above, potassium borate, calcium borate, magnesium borate, borate silicate, aluminum silicate borate hydroxide, silicate borate hydroxide fluoride, hydroxide silicate borate, sodium silicate borate, calcium silicate borate, aluminum borate, iron borate, copper borate, zinc borate). Organic borates include borate esters that have the formula: CₐH_{b}BO₃, where a is an integer of 3 to 100 and preferably in the range of 3 to 30, and b is an integer in the range of 9 to 300 and preferably in the range of 9 to 90. In some embodiments, the coating composition can include at least one quaternary ammonium compound (e.g., alkoxysilyl quaternary ammonium compounds). Alkoxysilyl quaternary ammonium compounds can have a general formula of:

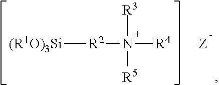

where R¹ is methyl, ethyl, propyl, isopropyl, butyl, isobutyl, or a combination thereof, R², R³, R⁴, R⁵ are each independently hydrocarbon moieties having between 1 to 30 carbon atoms, a substituted alkyl group, a unsubstituted alkyl group, a substituted alkenyl group, an unsubstituted alkenyl group, a substituted alkynyl group, an unsubstituted alkynyl group, a substituted aryl group, or an unsubstituted aryl group or derivatives thereof, and Z is an anionic atom or compound, preferably a halogen.

In some embodiments, the coating composition for treating the surface of materials may include a solvent. The solvent can be combined with the ingredients through a “wet process” misting mechanism or even vapor treatment method to disperse all the components to form a homogeneous entity. In some embodiments, the coating composition may include a base compound to a core unit or base of the sol-gel network. In some embodiments, the coating composition may include a bonding agent to aid bonding of the coating to a desired surface. In some embodiments, the coating composition may include a plasticizer to maintain elasticity of the sol-gel. In some embodiments, the coating composition may include a viscosity modifier to achieve a desired viscosity for the sol-gel. In some embodiments, the coating composition can include a chelating agent to enhance homogeneity of the organic/inorganic compounds or portions of compounds in the solution. The base compound used in the present invention can have a general formula of M(OR⁶)₄, where M is Si, Al, Ti, In, Sn or Zr, and R⁶ is a hydrogen, a substituted or unsubstituted alkyl group or a derivative thereof. In a preferred embodiment, the base compound is tetraethyl orthosilicate (Si(OCH₂CH₃)₄). The bonding compound used in the present invention can have a general formula of M(OR⁷)ₓR⁸_{y}, R⁹_{z}, where M is Si, Al, In, Sn or Ti, R⁷ is a hydrogen, a substituted or unsubstituted alkyl group or derivatives thereof, R⁸ is a hydrogen, a substituted or unsubstituted alkyl group or derivatives thereof, R⁹ is a substituted or unsubstituted epoxy or glycidoxy group; and x and z are each independent integer from 1 to 3, y is an integer from 0 to 2, and the sum of x, y and z is 4. In a preferred embodiments, the bonding agent is 3-glycidoxypropyltrimethoxysilane (Si(OCH₃)₃glycidoxy). The plasticizer used in the coating composition can have the general formula of M(OR¹⁰)₄₋ₓR¹¹ₓ, where M is Si, Al, In, Sn or Ti, R¹⁰ is a hydrogen, a substituted or unsubstituted alkyl group or derivatives thereof, and R¹¹ is a substituted or unsubstituted alkyl group, a substituted or unsubstituted alkenyl group, a substituted or unsubstituted alkynyl group, a substituted or unsubstituted aryl group or a derivative thereof, and x is 1, 2 or 3. In a preferred aspect, the plasticizer is trimethoxypropyl silane (Si(OCH₃)₃CH₂CH₂CH₃. The chelating agent can be an alkoxysilane, a metal oxide precursor, or both, having the general formula of M(OR¹²)ₓR¹³_{y}R¹⁴_{z}, where M is Si, Al, In, Sn or Ti, R¹² includes a hydrogen, a substituted or unsubstituted alkyl group or derivatives thereof, R¹³ includes a hydrogen, a substituted or unsubstituted alkyl group or derivatives thereof, R¹⁴ includes a substituted or unsubstituted alky or alkenyl group having from 3 to 20 carbon atoms or a substituted or unsubstituted amine (including primary, secondary and tertiary) or thiol, and x and z are each independently an integer from 1 to 3, y is an integer from 0 to 2, and the sum of x, y and z is 4. The chelating agent can be an alkoxysilane oligomer having the general structure of:

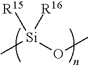

where R¹⁵ and R¹⁵ can be the same or different and are hydrogen, a substituted or unsubstituted alkyl or derivatives thereof.

The hydrophobic coating composition of the present invention can also include functional additives (e.g., a UV absorbing or blocking compound, an antireflective compound, an anti-abrasion compound, a fire-retardant compound, a conducting compound, or a color imparting compound). Without wishing to be bound by theory it is believed that the functional additive can chemically react with the base compound, the at least one bonding agent, the at least one plasticizer, or any combination thereof, or be encapsulated within a network of the sol-gel. In one instance, the coating composition does not include an amino-containing organoxysilane and an anhydride compound and/or the coating composition includes less than 50% by weight water, preferably less than 10% by weight water.

In some embodiments, the coating composition can be prepared by (a) obtaining at least one active ingredient, at least one base compound, at least one bonding agent, and at least one plasticizer, (b) adding the at least one active ingredient, the at least one base compound, the at least one bonding agent, and the at least one plasticizer to solvent to form a mixture, and (c) at mixing the mixture under acidic conditions (e.g., pH of 6 or less, or pH<5) to form a sol-gel. The mixture can be stirred at a temperature from 50 to 100° C. for about ½ hour to 10 days. The pesticides are either chemically reacted or physically entrapped/encapsulated with the materials used for the coating. In one aspect of the invention, a method of coating a substrate in need of a coating can include (a) obtaining a substrate (e.g., a fabric, a masonry material, an aquatic structure, soil, a bait, a fabric, or any combination thereof) and (b) applying to the substrate the coating compositions of the present invention, wherein the coating composition imparts pest and water resistance properties to the substrate. The pest resistance can be imparted to the outside surface of the substrate, impregnated in the substrate or incorporated into the substrate. In some embodiments, the coating composition can be deposited on the surface of substrates by spraying, misting, doctor-blading, padding, foaming, rolling or inkjet printing. In some embodiments, the coating composition may be applied to the soil as barrier treatment or incorporated into baits. In some embodiments, the coating composition is applied by (a) contacting the substrate with a solution comprising the coating composition and a solvent to coat the substrate (e.g., dipping or immersing the substrate in the solution) and (b) subjecting the coated material to conditions sufficient to remove the solvent and dry the material, where at least a portion of the coating composition penetrates the surface of the substrate. The conditions of step (b) can include a temperature of 25 to 200° C. and/or can be sufficient to crosslink the sol or sol-gel. In some embodiments, a surface treated with of a hydrophobic compound (e.g., fluoroalkylsilane compound, an alkylsilane compound, an alkoxyfluoroalkylsilane compound) can be used to increase the surface hydrophobicity of the resulting composite. The coating composition, hydrophobic composition, or both can generate a nanoscopic or a microscopic topography on the surface of the material.

In some embodiments a method of inhibiting leaching of an active compound (e.g., a pesticide) from a substrate is disclosed. The method can include applying coating composition described throughout the specification and drying the coated substrate. The coating composition inhibits leaching of the active compound from the substrate.

Also disclosed in the context of the present invention are embodiments 1 to 45. Embodiment is a hydrophobic coating composition for treating of a substrate, the hydrophobic coating composition comprising: (a) at least one active compound; and (b) a sol-gel derived from at least one base compound, at least one bonding agent, and at least one plasticizer, wherein the coating composition is hydrophobic. Embodiment 2 is the composition of embodiment 1, wherein the active compound is 1) capable of chemically reacting with the base compound, the at least one bonding agent, the at least one plasticizer, or any combination thereof, or 2) encapsulated within the sol-gel network. Embodiment 3 is the composition of any one of embodiments 1 to 2, wherein the active compound comprises a pesticide capable of destroying pests, preferably a termite. Embodiment 4 is the composition of any one of embodiments 1 to 3, wherein the pesticide comprises an algaecide, an antifouling agent, an antimicrobial, a biocide, a fungicide, a herbicide, an insecticide, a miticide, a molluscicide, a nematicide, a ovicide, a pheromone, a rodenticide or any combination thereof. Embodiment 5 is the composition of any one of embodiments 1 or 4, wherein the pesticide comprises a boron compound, a quaternary ammonium salt, or both. Embodiment 6 is the composition of embodiment 5, wherein the boron compound comprises an inorganic borate, an organic borate, or both, preferably, a metal borate, a borate mineral, a borate ester, more preferably a sodium borate compound. Embodiment 7 is the composition of embodiment 6, wherein the sodium borate is disodium octaborate tetrahydrate, sodium tetraborate decahydrate, sodium tetraborate pentahydrate, sodium tetraborate, sodium metaborate, sodium pentaborate, and mixtures of any of the above, potassium borate, calcium borate, magnesium borate, borate silicate, aluminum silicate borate hydroxide, silicate borate hydroxide fluoride, hydroxide silicate borate, sodium silicate borate, calcium silicate borate, aluminum borate, iron borate, copper borate, zinc borate. Embodiment 8 is the composition of embodiment 6, wherein the borate ester has a general formula of:

CₐH_{b}BO₃, (I)

where a is an integer of 3 to 100 and preferably in the range of 3 to 30, and b is an integer in the range of 9 to 300 and preferably in the range of 9 to 90. Embodiment 9 is the composition of embodiment 5, wherein the quaternary ammonium salt comprises an alkoxysilyl quaternary ammonium compound. Embodiment 10 is composition of embodiment 9, wherein the alkoxysilyl quaternary ammonium compound has a general formula of:

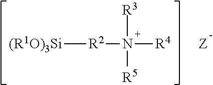

where R¹ is methyl, ethyl, propyl, isopropyl, butyl, isobutyl, or a combination thereof; R², R³, R⁴, R⁵ are each independently hydrocarbon moieties having between 1 to 30 carbon atoms, a substituted alkyl group, a unsubstituted alkyl group, a substituted alkenyl group, an unsubstituted alkenyl group, a substituted alkynyl group, an unsubstituted alkynyl group, a substituted aryl group, or an unsubstituted aryl group or derivatives thereof; and Z is an anionic atom or compound, preferably a halogen. Embodiment 11 is the composition of any one of embodiments 1 to 10, wherein each of the least the base compound, the at least one bonding agent and the at least one plasticizer are an alkoxysilane compound, a metal oxide precursor, or both. Embodiment 12 is the composition of embodiment 11, wherein the base compound has a general formula of M(OR⁶)₄ where M is Si, Al, Ti, In, Sn or Zr; and R⁶ is a hydrogen, a substituted or unsubstituted alkyl group or a derivative thereof. Embodiment 13 is the composition of embodiment 12, wherein the base compound is tetraethyl orthosilicate (Si(OCH₂CH₃)₄). Embodiment 14 is the composition of any one of embodiments 1 to 13, wherein the bonding compound has a general formula of:

M(OR⁷)ₓR⁸_{y}R⁹_{z},

where M is Si, Al, In, Sn or Ti; R⁷ is a hydrogen, a substituted or unsubstituted alkyl group or derivatives thereof; R⁸ is a hydrogen, a substituted or unsubstituted alkyl group or derivatives thereof; R⁹ is a substituted or unsubstituted epoxy or glycidoxy group; and x and z are each independently an integer from 1 to 3, y is an integer from 0 to 2, and the sum of x, y and z is 4. Embodiment 15 is the composition of embodiment 14, wherein the bonding agent is 3-glycidoxypropyltrimethoxysilane (Si(OCH₃)₃glycidoxy). Embodiment 16 is the composition of embodiment 15, wherein the plasticizer has the general formula of:

M(OR¹⁰)₄₋ₓR¹¹ₓ,

where M is Si, Al, In, Sn or Ti; R¹⁰ is a hydrogen, a substituted or unsubstituted alkyl group or derivatives thereof; and R¹¹ is a substituted or unsubstituted alkyl group, a substituted or unsubstituted alkenyl group, a substituted or unsubstituted alkynyl group, a substituted or unsubstituted aryl group or a derivative thereof; and x is 1, 2 or 3. Embodiment 17 is the composition of embodiment 16, wherein the plasticizer is trimethoxypropyl silane (Si(OCH₃)₃CH₂CH₂CH₃. Embodiment 18 is the composition of any one of embodiments 1 to 17, comprising a chelating agent, a viscosity modifier, or a functional additive. Embodiment 19 is the composition of embodiment 18, wherein the chelating agent is an alkoxysilane, metal oxide precursor, or both having the general formula of:

M(OR¹²)ₓR¹³_{y}R¹⁴_{z},

where M is Si, Al, In, Sn or Ti; R¹² includes a hydrogen, a substituted or unsubstituted alkyl group or derivatives thereof, R¹³ includes a hydrogen, a substituted or unsubstituted alkyl group or derivatives thereof; R¹⁴ includes a substituted or unsubstituted alky or alkenyl group having from 3 to 20 carbon atoms or a substituted or unsubstituted amine (including primary, secondary and tertiary) or thiol; and x and z are each independently an integer from 1 to 3, y is an integer from 0 to 2, and the sum of x, y and z is 4. Embodiment 20 is the composition of embodiment 19, wherein the chelating agent is an alkoxysilane oligomer having the general structure of:

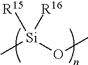

where R¹⁵ and R¹⁵ can be the same or different and are hydrogen, a substituted or unsubstituted alkyl or derivatives thereof. Embodiment 21 is the composition of embodiment 20, wherein the functional additive is 1) capable of chemically reacting with the base compound, the at least one bonding agent, the at least one plasticizer, or any combination thereof, or 2) encapsulated within a network of the sol-gel network. Embodiment 22 is the composition of embodiment 21, wherein the functional additive is a UV absorbing or blocking compound, an antireflective compound, an anti-abrasion compound, a fire-retardant compound, a conducting compound, or a color imparting compound. Embodiment 23 is the composition of any one of embodiments 1 to 22, wherein the coating composition does not include an amino-containing organoxysilane and an anhydride compound. Embodiment 24 is the composition of any one of embodiments 1 to 24, wherein the coating composition comprises less than 50% by weight water, preferably less than 10% by weight water. Embodiment 25 is the composition of any one of embodiments 1 to 24, wherein the coating composition inhibits leaching of the pesticide from a substrate.

Embodiment 26 is a method of making a coating composition of any one of embodiments 1 to 25, the method comprising: (a) obtaining at least one active ingredient, at least one base compound, at least one bonding agent, and at least one plasticizer; (b) adding the at least one active ingredient, the at least one base compound, the at least one bonding agent, and the at least one plasticizer to a solvent to form a mixture; and (c) mixing the mixture under acidic conditions to form a sol or sol-gel. Embodiment 27 is the method of embodiment 26, wherein acidic conditions comprise a pH of 6 or less, preferably 5. Embodiment 28 is the method of any one of embodiments 26 to 27, wherein step (c) comprises a temperature from 50° C. to 100° C., preferably 60° C. Embodiment 29 is the method of any one of embodiments 26 to 28, wherein the at least one base compound, the at least one bonding agent, and the at least one plasticizer react in step (c) to form a sol or a sol-gel. Embodiment 30 is the method of any one of embodiments 26 to 29, wherein the active ingredient chemically reacts with the base compound, the at least one bonding agent, the at least one plasticizer, or any combination thereof in step (c) or is encapsulated within the sol-gel network in step (c).

Embodiment 31 is a method of coating a substrate in need of a coating or imparting pest and water resistance properties to the substrate, the method comprising: (a) obtaining a substrate; and (b) applying to the substrate the coating compositions of any one of embodiments 1 to 25, wherein the coating composition imparts pest and water resistance properties to the substrate. Embodiment 32 is the method of embodiment 31, wherein the substrate is a fabric, a masonry material, an aquatic structure, soil, a bait, a fabric, or any combination thereof. Embodiment 33 is the method of any one of embodiments 31 to 32, wherein the pest resistance is imparted to the outside surface of the substrate, impregnated in the substrate or incorporated into the substrate. Embodiment 34 is the method of any one of embodiments 31 to 33, wherein the coating composition is applied by spraying, misting, vapor deposition, doctor-blading, padding, foaming, rolling or inkjet printing. Embodiment 35 is the method of any one of claims 31 to 33, wherein the coating composition is applied by: (a) contacting the substrate with a solution comprising the coating composition and a solvent to coat the substrate; and (b) subjecting the coated material to conditions sufficient to remove the solvent and dry the material, wherein at least a portion of the coating composition penetrates the surface of substrate. Embodiment 36 is the method of embodiment 35, wherein contacting in step (a) comprises dipping or immersing the substrate in the solution. Embodiment 37 is the method of any one of embodiments 35 to 36, wherein the conditions of step (b) comprise a temperature of 25 to 200° C. Embodiment 38 is the method of any one of embodiments 36 to 37, wherein the conditions of step (b) are sufficient to crosslink the sol or sol-gel. Embodiment 39 is the method of any one of embodiments 31 to 38, further comprising applying a hydrophobic composition to the substrate prior to step (b) or after step (b). Embodiment 40 is the method of any one of embodiments 31 to 39, wherein the coating composition, hydrophobic composition, or both generates a nanoscopic or a microscopic topography on the surface of the material. Embodiment 41 is the method of any one of any one of embodiments 31 to 40, wherein the hydrophobic composition is a fluoroalkylsilane compound, an alkylsilane compound, an alkoxyfluoroalkylsilane compound. Embodiment 42 is the method of any one of embodiments 31 to 41, wherein the substrate is wood, a textile, a masonry material, an aquatic structure, or any combination thereof. Embodiment 43 is the method of any one of embodiments 31 to 42, wherein the coating composition imparts the active component to an inner surface of the substrate.

Embodiment 44 is a method of inhibiting leaching of an active compound from a substrate comprising: (a) applying coating composition of any one of claims 1 to 25 to a substrate; and (b) drying the coated substrate, wherein the coating composition inhibits leaching of the active compound from the substrate. Embodiment 45 is the method of embodiment 44, wherein the active compound is a pesticide.

The term “pesticide” refers to a substance that is capable of attracting or seducing and then destroying or mitigating any living organisms that occurs where they are not wanted or that cause damage to materials.

The term “insect resistant” refers to the ability of a material to resist entrance of insects or minimize or inhibit decay caused by insects.

The term “termite resistant” refers to the ability of a material to resist the attack and feeding of termites. Termite resistance can be measured using the Standard Method for Laboratory Evaluation to Determine Resistance to Subterranean Termites (AWPA E1-13, where AWPA stands for American Wood Protection Association).

The term “fungal resistant” refers to the ability of a material to resist the attachment, growth, and spreading fungal strains. Fungal resistance can be determined using ASTM Standard Test Methods.

The term “antimicrobial” in the context of this patent is a term used to describe any applicable surface or material that has been coated, sealed, or treated to impart the ability to kill microorganisms (i.e., “microbicidal”) and substantially inhibit their growth. The United States Environmental Protection Agency (EPA) states this use as to disinfect, sanitize, reduce, or mitigate growth or development of microbiological organisms. Generally, the application is to protect against bacteria, viruses, fungi, protozoa, algae, or slime. Indeed as a more specific designation one may also define and differentiate the microbe(s) being killed such as, for example, fungi, then term would be specifically anti-fungal. A surface or material that exhibits limited anti-microbial behavior or properties is said to be “microbial resistant.” Specifically, the material may be seen to inhibit or impede the rate at which microbes grow on or attach to a surface.

The terms “antifouling” and “fouling-resistance” are defined as a property exhibited by specifically designed functional coatings or functionalized/chemically-modified surfaces that either inhibit or aid in the removal of a select assortment of aquatic biofouling agents.

The term “biofouling” refers to the undesired settlement, anchoring, and/or colonization of the aforementioned biofouling agents on the surfaces or internal components of either a naturally occurring or man-made aquatic structure. Biofouling has remained a significant problem for both fixed and movable aquatic structures. Examples of fixed and movable aquatic surfaces susceptible to biofouling include but are not limited to structural/functional/aesthetic components of piers/docks/jetties/reservoirs/dams/floodgates and the exterior hulls of either surface-dwelling and/or submarine aquatic vessels, respectively. Larger biofouling agents such as Cirripedia cemented to the exterior hulls of aquatic vessels have been shown to increase hydrodynamic drag and/or incite premature structural oxidation, which decrease commerce time, increase fuel/energy consumption, and significantly increase vessel maintenance costs.

The term “sol” refers to a colloidal solution, which is a precursor to a sol-gel. The term “sol-gel” refers to an integrated network of either discrete particles or network polymers.

The term “about” or “approximately” are defined as being close to as understood by one of ordinary skill in the art. In one non-limiting embodiment the terms are defined to be within 10%, preferably within 5%, more preferably within 1%, and most preferably within 0.5%.

The term “substantially” and its variations are defined as being largely but not necessarily wholly what is specified as understood by one of ordinary skill in the art. In one non-limiting embodiment substantially refers to ranges within 10%, within 5%, within 1%, or within 0.5%.

The terms “inhibiting” or “reducing” or “preventing” or “avoiding” or “resistance” or any variation of these terms, when used in the claims and/or the specification, includes any measurable decrease or complete inhibition to achieve a desired result.

The term “effective,” as that term is used in the specification and/or claims, means adequate to accomplish a desired, expected, or intended result.

The use of the word “a” or “an” when used in conjunction with the terms “comprising,” “having,” “including,” or “containing” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The coatings of the present invention can “comprise,” “consist essentially of,” or “consist of” particular ingredients, components, compositions, etc., disclosed throughout the specification. With respect to the transitional phase “consisting essentially of,” in one non-limiting aspect, a basic and novel characteristic of the coatings of the present invention are their abilities to provide pest resistance and water repellency for a substrate, which inhibits leaching of the pesticide from the substrate.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein

FIGS. 1A and 1B are images of before and after results from a Standard Method for Laboratory Evaluation to Determine Resistance to Subterranean Termites for a pristine wood sample.

FIGS. 1C and 1D are images of before and after results from a Standard Method for Laboratory Evaluation to Determine Resistance to Subterranean Termites for a comparative wood sample coated with the composition of the present invention.

FIGS. 1E and 1F are images of before and after results from a Standard Method for Laboratory Evaluation to Determine Resistance to Subterranean Termites for a wood sample coated with the composition a known pesticide.

### DETAILED DESCRIPTION OF THE INVENTION

A discovery has been made that solves the problems of conventional compositions used to inhibit or prevent damage or destruction of substrates caused by pests. The coating compositions of the present invention provide protection against pests such as insects, fungi, microbes, and/or fouling organisms, thereby improving the resistance of the substrate to insect infestation (e.g., termites), fungi growth, microbial growth, and/or fouling. The sol-gel (e.g., polymeric matrix) and/or the hydrophobic nature of the coating composition can substantially inhibit leaching of the pesticide from the inner and/or outer surface of the substrate, thereby providing for a prolonged or long-lasting effect when compared with convention compositions.

### A. Pests

Non-limiting examples of pests include insects, fungi, microorganisms and fouling organisms. Non-limiting examples of insects include termites, carpenter bees, carpenter ants, wood-boring beetle, bark beetles, powderpost beetles, Bostrichid beetles. These will be discussed in more detail in the following sections.

1. Insects

There are many types of insects that attack, damage and/or infest wood and wood products. The major categories of wood destroying insects (other than termites) are described below. Carpenter ants (Camponotus spp.), also known as sugar ants, build nests inside cavities of wood, such as in the space between double wall of a building, in hollow doors or cavity left by rotten wood, preferably in dead, damp wood. Once they establish their nest, their activity generated enough moisture to rot wood, enabling them to enlarge their nest and damage the wood. They do not consume the wood; however, they hollow out sections of the wooden structure and are a widespread nuisance and major cause of structural damage. One of the most familiar species in the United States is the black carpenter ant (Camponotus pennsylvanicus). The genus includes over 1,000 species.

Carpenter Bees (the genus Xylocopa in the subfamily Xylocopinae) are large bees, nearly all of which species build their nests in burrows in dead wood, bamboo, or structural timbers (except those in the subgenus Proxylocopa, which nest in the ground). Over 500 species of carpenter bees are in the 31 subgenera. Carpenter bees do not eat wood. They discard the bits of wood, or reuse particles to build partitions between cells.

Wood-boring beetle consists of many species and families of beetles who eat and destroy wood either in larval or adult form. The four most notable families are longhorn beetles (family Cerambycidae), bark beetles and weevils, and metallic flat-headed borers and powderpost beetle (family Lyctinae). Bark beetle and wood borers bore through the bark of trees, feeding in the region between the bark and the wood. Because their activity is limited to the superficial layers, they do not weaken wood, however they inflict monetary loss to people with log cabins, wood furniture etc. Wood borer larvae borrow or tunnel into solid wood. Once developed, they emerge from the wood leaving a large conspicuous exit hole on the finished surface. Powderpost beetle's larvae of these beetles feed on wood and, over time, can reduce it to a mass of fine powder. Because of this behavior, they are considered pests. Three families of insect belong to this group. Powderpost beetles are a group of seventy species of wood boring beetles classified in the insect subfamily Lyctinae. Powderpost beetles can be serious pests of structures. The most common types of powderpost beetles are Anobiid, Lyctid, and Bostrichid beetles.

A common pest is a termite. Termites feed on cellulose-based plant material and their presence in human made structures often goes undetected for long periods of time, earning them the name “Silent destroyers”. There are three main termite types—subterranean, drywood, or dampwood. Subterranean Termites belong to the family Rhinotermitidae and contain 14 genera and over 300 species of termites. Some of the most notable genera are: Reticulitermes spp., Coptotermes spp. and Heterotermes spp. and species such as, Coptotermes formosanus, Coptotermes gestroi, and Reticulitermes flavipes, are recognized as severe pests. The Eastern subterranean termite, Reticulitermes flavipes (Kollar) is found throughout the Eastern United States and has a very broad geographical distribution and it may be the one that causes the most economical damage. The voracious Formosan subterranean termite, Coptotermes formosanus (Shiraki) is also a member of Rhinotermitidae. It is an invasive species and was imported into the US about sixty years ago and nowadays can be found across the southern United States, from California to Louisiana to Florida and Georgia. Coptotermes formosanus lives in the soil underground and builds the colonies which are typically larger than subterranean colonies, numbering up to hundreds of thousands of members. This size difference allows them to cause significantly more severe damage than other species of termites. Formosan termites also have the ability to form cartons (nests inside the colony made of chewed wood, soil and undigested cellulose) to retain water for the colony until they can find a more permanent water source. Subterranean termites, which can live in every U.S. state except Alaska, are responsible for the majority of termite damage in this country. This termite species prefers to eat soft, spring wood fiber, which means wood damaged by subterranean termites has a honeycombed appearance, with only the grain left behind. Drywood Termites belong to the family Kalotermitidae (Cryptotermes spp. and Incisitermes spp.) and typically live in wood, such as dead trees and can cause significant damage to homes, commonly targeting the wood in structural timbers, framing, and furniture and hardwood floors. Kalotermitidae include 22 genera and 419 species. Unlike subterranean termites, drywood termites do not require contact with soil. This termite species can tolerate dry conditions for long periods of time, taking all of the moisture it needs from the wood it consumes and extracting as much water as possible from the feces to conserve it. The most destructive drywood termites in the U.S. include the western drywood termite (Incisitermes minor) and the tropical rough-headed drywood termite (Cryptotermes brevis). Dampwood Termites belong to the families Kalotermitidae and Hodotermitidae (Zootermopsis spp. and Neotermes spp.) and thrive in wood with high moisture content, such as wood near water leaks in wall voids, in moist and decaying wood in dead trees, stumps and logs. They do not require staying underground or in contact with the soil to survive.

2. Fungi and Biofouling Organisms

Non-limiting examples of fungi include the Ascomycota Phylum. Non-limiting examples of Ascomycota Phylum include Aspergillus niger—ATCC#6275, Penicillium citrinum—ATCC#9849, and Aureobasidium pullulans—ATCC#9348 (where ATCC: American Type Culture Collection). These fungi can decompose cellulose (wood, paper and paperboard), textiles, paint coatings, plastics, insulation and leather. These fungi can produce “fuzzy” mycelial colonies on organic matter and are frequently referred to as “molds.” Non-limiting examples of microorganisms includes bacteria. Non-limiting examples of materials include wood, masonry materials, and aquatic structures.

Non-limiting aquatic biofouling organisms include aquatic microbes, algae (e.g. diatoms, seaweed and charophyta) of either the freshwater, saltwater, or brackish water variety, crustaceans (e.g. cirripedia and byssus-containing bivalve-mollusks) of either the freshwater, saltwater, or brackish water variety, and corals.

### B. Coating Compositions

The coating compositions of the present invention can be used to treat substrates that are susceptible to damage from pests or infestation of pests. The coating compositions of the present invention are capable of impregnating the substrate with the pesticide. In some embodiments, the pesticide is distributed, or substantially distributed, throughout the inner portion of the substrate. The hydrophobic properties of the coating composition inhibit, or substantially inhibit, leaching of the pesticide when the substrate is contacted with water. These and other non-limiting aspects of the present invention are discussed in further detail in the following sections.

The coating composition can be a composite material having the active component dispersed, bonded, or encapsulated in a sol-gel or polymeric matrix. The coating composition can include a pesticide that is coupled to a sol-gel network. The pesticide can be bonded to the sol-gel through chemical bonds, encapsulated, and/or partially encapsulated in the sol-gel network. The sol or sol-gel can be derived from at least one base compound, at least one bonding agent, and at least one plasticizer. The composition can also include a chelating agent, a viscosity modifier, functional additives, a hydrophobic compound, or any combination thereof. The coating composition can include less than 50% by volume water, 10 vol. % or less of water, 5 vol. % or less, or 1 vol. % or less. The coating composition can be a solution having a desired viscosity or a gel.

The coating composition ingredients are discussed in further detail in the following sections.

1. Pesticides

Pesticides can be included in the coating composition to attract, seduce, destroy, or mitigate any living organisms that occurs where they are not wanted or that cause damage to materials. Non-limiting examples of pesticides can include algaecides, antifouling agents, antimicrobials, biocides, fungicides, herbicides, insecticides, miticides, molluscicides, nematicides, ovicides, pheromones, or rodenticides or any combination thereof.

i. Borates

In some aspects of the invention, the coating composition can include at least one boron compound. Boron compounds which can be used in the present invention include metal borates, borate minerals, borate esters and other inorganic or organic borates. Typical examples of metal borates include compounds such as, but not limited to, sodium borate—including disodium octaborate tetrahydrate (Timbor), sodium tetraborate decahydrate (Borax), sodium tetraborate pentahydrate, sodium tetraborate (anhydrous Borax), sodium metaborate, sodium pentaborate, and mixtures of any of the above, potassium borate, calcium borate, magnesium borate, borate silicate, aluminum silicate borate hydroxide, silicate borate hydroxide fluoride, hydroxide silicate borate, sodium silicate borate, calcium silicate borate, aluminum borate, iron borate, copper borate, zinc borate, etc. Non-limiting examples of other inorganic borates which may be used in the present invention include ammonium borate, boric acid, boron oxide, boron fluoride and boron chloride. Organic borates include borate esters that have the general formula (I):

CₐH_{b}BO₃, (I)
where a is an integer of 3 to 100 and preferably in the range of 3 to 30, and b is an integer in the range of 9 to 300 and preferably in the range of 9 to 90.
   Non-limiting examples of borate esters include trimethyl borate, triethyl borate, tri-n-propyl borate, tri-iso-propyl borate, tri-n-butyl borate, tri-sec-butyl borate, tri-tert-butyl borate, tri-iso-butyl borate, tri-pentyl borate, tri-hexyl borate and triphehyl borate. It should be appreciated that borate esters having ester substituents which are non-identical may also be used. The “ester substituents” are the groups connect directly to the boron.

ii. Quaternary Ammonium Salts

In some embodiments, the coating composition can include at least one quaternary ammonium compound. Quaternary ammonium compounds which can be used in the present invention include alkoxysilyl quaternary ammonium compounds. Without wishing to be bound by theory, it is believed that these compound exhibit antimicrobial properties that can be effectively implemented in biocidal systems. Non-limiting examples of biocidal systems which include microbicides, fungicides, bactericides and algaecides. In effect, the hydrolysable alkoxy moieties of alkoxysilyl quaternary ammonium compounds may undergo condensation reactions with silanol, hydroxyl, or halogen moieties of a polymeric host matrix and/or with other alkoxysilyl quaternary ammonium compounds in either the presence or absence of a catalyst. The antimicrobial properties of alkoxysilyl quaternary ammonium compounds arise from positively charged ammonium moieties that exhibit an affinity for the anionic heads of phospholipids that function as critical bilayer-forming components of most cellular membranes. The proximity between such ammonium moieties and the lipid bilayers of cellular membranes is enhanced by alkoxysilyl quaternary ammonium compounds with longer alkyl chain moieties that facilitate weak intermolecular attraction between the two. This ionic interaction effectively disrupts cellular activity via gradual dissociation of cellular membrane lipid bilayers (lysis), which eventually results in rupturing of affected cellular membranes, leakage of cellular contents, and ultimately cellular death. The alkoxysilyl quaternary ammonium compounds used may have a general formula (II):

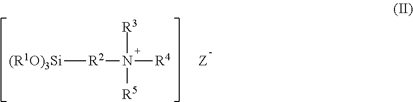

where R¹ is methyl, ethyl, propyl, isopropyl, butyl, isobutyl, or a combination thereof;
R², R³, R⁴, R⁵ are each independently hydrocarbon moieties having between 1 to 30 carbon atoms, a substituted alkyl group, a unsubstituted alkyl group, a substituted alkenyl group, an unsubstituted alkenyl group, a substituted alkynyl group, an unsubstituted alkynyl group, a substituted aryl group, or an unsubstituted aryl group or derivatives thereof; and
Z is an anionic atom or compound, preferably a halogen.

Non-limiting examples of alkoxysilyl quaternary ammonium compounds include compounds such as but not limited to, 3-(N-Styrlmethyl-2-aminoethylamino)propyltrimethoxysilane hydrochloride, 3-(Trimethoxysilyl)propyl-N,N,N-trimethylammonium chloride, 4-(Trimethoxysilylethyl)benzyltrimethylammonium chloride, Dimethyloctadecyl[(3-trimethoxysilyl)propyl]ammonium chloride, N-(2-N-Benzylaminoethyl)-3-aminopropyltrimethoxysilane hydrochloride, N,N-Didecyl-N-methyl-N-(3-trimethoxysilylpropyl)ammonium chloride, Octadecylbis(triethoxysilylpropyl)ammonium chloride, S-(Trimethoxysilylpropyl)isothiouronium chloride and Tetradecyldimethyl(3-trimethoxysilylpropyl)ammonium chloride.

iii. Other Pesticides

In some embodiments, one or more other pesticide may be used in the coating compositions of the present invention. Non-limiting examples of other pesticides include organophosphate pesticides, carbamate pesticides, organochlorine insecticides, pyrethrins pesticides (pyrethrin 1, pyrethrin 2, cinerin 1, cinerin 2, jasmolin 1, and jasmolin 2) and pyrethroid pesticides (allethrin stereoisomers, bifenthrin, beta-cyfluthrin, cyfluthrin, cypermethrin, cyphenothrin, deltamethrin, esfenvalerate, fenpropathrin, tau-fluvalinate, lambda-cyhalothrin, gamma-cyhalothrin, imiprothrin, 1-RS-cis-permethrin, permethrin, prallethrin, resmethrin, sumithrin (d-phenothrin), tefluthrin, tetramethrin, tralomethrin, and zeta-cypermethrin), alkyl amino propane pesticides, benzene sulfonate pesticides, hydantoin pesticides, imidazoline pesticides, isothiazolone pesticides, organotin pesticides, quaternary ammonium cation pesticides and triazine pesticides, antifungal compounds antimicrobial compounds, antibacterial compound or any combinations thereof. These pesticides can be used alone or in combination with the boron compounds and/or the quaternary ammonium salts described herein.

2. Sol or Sol-Gel

i. Solvent

In some embodiments, coating composition can include a solvent or a mixture of solvents, whether through a ‘wet process’ misting mechanism or even vapor treatment method to disperse all the components to form a homogeneous entity. Non-limiting examples of solvents used to disperse all the components to form a homogeneous solution can include water, methanol, ethanol, n-propanol, isopropanol, n-butanol, isobutanol, ethylene glycol, glycerol acetone, acetonitrile, dioxane, tetrahydrofuran, dimethylformamide, dimethyl sulfoxide or any mixture thereof. In a preferred embodiment, a mixture of water and ethanol is used. In some aspects, a minimal amount of water is used as a solvent. Water may be generated during the chemical reactions, however, it may be in minimal quantities.

ii. Base Compound

The base compound to form the body or core unit of the sol or sol-gel (e.g., a repeating unit of a polymeric matrix). In some embodiments, the base compound can include at least one alkoxysilane, metal oxide precursor, or a combination thereof having a general formula (III):

M(OR⁶)₄ (III)
where M is Si, Al, Ti, In, Sn or Zr; and
R⁶ is a hydrogen, a substituted or unsubstituted alkyl group, or a derivative thereof.

Non-limiting examples of the base compound includes tetramethyl orthosilicate, tetraethyl orthosilicate, tetraisopropyl orthosilicate, tetra(tert-butyl) orthosilicate, tetra(sec-butyl) orthosilicate, aluminum methoxide, aluminum ethoxide, aluminum isopropoxide, aluminum tert-butoxide, aluminum tri-sec-butoxide, titanium methoxide, titanium ethoxide, titanium isopropoxide, titanium tert-butoxide, titanium tri-sec-butoxide and derivatives bearing similar structures.

iii. Bonding Compound

In some embodiments, the bonding compound or a mixture of bonding compound can aid in bonding of the coating composition to a desired surface. The bonding compound can be at least one alkoxysilane, metal oxide precursor, or a combination thereof, having a general formula (IV):

M(OR⁷)ₓR⁸_{y}R⁹_{z} (IV)
where M is Si, Al, In, Sn or Ti;
R⁷ is a hydrogen, a substituted or unsubstituted alkyl group or derivatives thereof;
R⁸ is a hydrogen, a substituted or unsubstituted alkyl group or derivatives thereof;
R⁹ is a substituted or unsubstituted epoxy or glycidoxy; and
x and z are each independently an integer from 1 to 3, y is an integer from 0 to 2, and the sum of x, y and z is 4.

Non-limiting examples of bonding compounds can include 2-(3,4-epoxycyclohexyl)ethyltrimethoxysilane, 2-(3,4-epoxycyclohexyl)-ethyltriethoxysilane, 5,6-epoxyhexyltrimethoxysilane, 5,6-epoxyhexyltriethoxysilane, glycidoxymethyltrimethoxysilane, glycidoxymethyltriethoxysilane, 2-glycidoxyethyltrimethoxysilane, 2-glycidoxyethyltriethoxysilane, 3-glycidoxypropyltrimethoxysilane, 3-glycidoxypropyltriethoxysilane, 4-glycidoxybutyltrimethoxysilane, 4-glycidoxybutyltriethoxysilane and derivatives bearing similar structures.

iv. Plasticizer Compounds

In some embodiments, the coating composition includes a plasticizer compound or a mixture of plasticizer compounds. A plasticizer compound can assist in maintaining elasticity of the sol-gel. The plasticizer can include at least one alkoxysilane, metal oxide precursor or a combination thereof having a general formula (V):

M(OR¹⁰)₄₋ₓR¹¹ₓ, (V)
where M is Si, Al, In, Sn or Ti;
R⁹ is a hydrogen, a substituted or unsubstituted alkyl or derivatives thereof;
R¹⁰ is a substituted or unsubstituted alkyl, a substituted or unsubstituted alkenyl, a substituted or unsubstituted alkynyl, a substituted or unsubstituted aryl or derivatives thereof; and
x is an integer from 1 to 3.

Non-limiting examples of plasticizers can include trimethoxymethylsilane, dimethoxydimethylsilane, methoxytrimethylsilane, trimethoxyethylsilane, dimethoxydiethyl silane, methoxytriethyl silane, trimethoxypropylsilane, dimethoxydipropylsilane, methoxytripropylsilane, trimethoxyisobutylsilane, triethoxyisobutylsilane, dimethoxydiisobutylsilane, diethoxydiisobutylsilane, trimethoxyphenylsilane, dimethoxydiphenylsilane, methoxytriphenylsilane, trimethoxyphenethylsilane, dimethoxydiphenethylsilane, methoxytriphenethylsilane, triethoxymethylsilane, diethoxydimethylsilane, ethoxytrimethylsilane, triethoxyethylsilane, diethoxydiethyl silane, ethoxytriethyl silane, triethoxypropylsilane, diethoxydipropylsilane, ethoxytripropylsilane, triethoxyphenylsilane, diethoxydiphenylsilane, ethoxytriphenylsilane, triethoxyphenethylsilane, diethoxydiphenethylsilane, ethoxytriphenethylsilane and derivatives bearing similar structures.

3. Other Compounds

The coating composition can include one or more optional ingredients that can be used to enhance homogeneity, viscosity and/or hydrophobic/superhydrophobic properties of the coating composition. These ingredients are discussed in further details in the following sections.

i. Chelating Compounds

Chelating compounds or a mixture of chelating compounds can be used to enhance or improve the homogeneity of the organosiloxy compounds or the organic metallic precursors (metal oxide precursor) in the coating composition, coating composition solutions or during manufacture of the coating composition. Non-limiting examples of chelating agents can include at least one alkoxysilane, at least one metal oxide precursor or a combination thereof having a general formula (VI):

M(OR¹²)ₓR¹³_{y}R¹⁴_{z} (VI)
where M is Si, Al, In, Sn or Ti;
R¹² includes a hydrogen, a substituted or unsubstituted alkyl group or derivatives thereof;
R¹³ includes a hydrogen, a substituted or unsubstituted alkyl group or derivatives thereof;
R¹⁴ includes a substituted or unsubstituted alky or alkenyl group having from 3 to 20 carbon atoms or a substituted or unsubstituted amine (including primary, secondary and tertiary) or thiol; and
x and z are each independently an integer from 1 to 3, y is an integer from 0 to 2, and the sum of x, y and z equals 4.

Non-limiting examples of chelating agents include trimethoxyphenylsilane, dimethoxymethylphenylsilane, methoxydimethylphenylsilane, trimethoxyphenethylsilane, dimethoxymethylphenethylsilane, methoxydimethylphenethylsilane, trimethoxyoctylsilane, dimethoxymethyloctylsilane, methoxydimethyloctylsilane, trimethoxydodecylsilane, dimethoxymethyldodecylsilane, methoxydimethyldodecylsilane, trimethoxydecylsilane, dimethoxymethyldecylsilane, methoxydimethyldecylsilane, trimethoxyoctadecylsilane, dimethoxymethyloctadecylsilane, methoxydimethyloctadecylsilane, trimethoxyhexylsilane, dimethoxymethylhexylsilane, methoxydimethylhexylsilane, trimethoxy(cyclohexylmethyl)silane, dimethoxymethyl(cyclohexylmethyl)silane, methoxydimethyl(cyclohexylmethyl)silane, triethoxyphenylsilane, diethoxymethylphenylsilane, ethoxydimethylphenylsilane, triethoxyphenethylsilane, diethoxymethylphenethylsilane, ethoxydimethylphenethylsilane, triethoxyoctylsilane, diethoxymethyloctylsilane, ethoxydimethyloctylsilane, triethoxydodecylsilane, diethoxymethyldodecylsilane, ethoxydimethyldodecylsilane, triethoxydecylsilane, diethoxymethyldecylsilane, ethoxydimethyldecylsilane, triethoxyoctadecylsilane, diethoxymethyloctadecylsilane, ethoxydimethyloctadecylsilane, triethoxyhexylsilane, diethoxymethylhexylsilane, ethoxydimethylhexylsilane, triethoxy(cyclohexylmethyl)silane, diethoxymethyl(cyclohexylmethyl)silane, ethoxydimethyl(cyclohexylmethyl)silane and derivatives bearing similar structures, N-3-aminopropyltrimethoxysilane, 3-aminopropyltriethoxysilane, 2-aminoethyltrimethoxysilane, 2-aminoethyltriethoxysilane, N-methylaminopropyltrimethoxysilane, N-methylaminopropyltriethoxysilane 4-aminobutylmethyldimethoxysilane, 4-aminobutylmethyldiethoxysilane, 3-aminopropyldimethylmethoxysilane, 3-aminopropyldimethylethoxysilane, 3-aminopropylmethyldimethoxysilane, 3-aminopropylmethyldiethoxysilane, N,N-dimethyl-3-aminopropyltrimethoxysilane, N,N-dimethyl-3-aminopropyltriethoxysilane, N,N-diethyl-3-aminopropyltrimethoxysilane, N,N-diethyl-3-aminopropyltriethoxysilane, N,N-diethylaminomethyltrimethoxysilane, N,N-diethylaminomethyltriethoxysilane, bis(2-hydroxyethyl)-3-aminopropyltrimethoxysilane, bis(2-hydroxyethyl)-3-aminopropyltriethoxysilane, N-(2′-aminoethyl)-3-aminopropyltrimethoxysilane, N-(2′-aminoethyl)-3-aminopropyltriethoxysilane, N-butyl-3-aminopropyltrimethoxysilane, N-butyl-3-aminopropyltriethoxysilane, N-octyl-3-aminopropyltrimethoxysilane, N-octyl-3-aminopropyltriethoxysilane, N-cyclohexyl-3-aminopropyltrimethoxysilane, N-cyclohexyl-3-aminopropyltriethoxysilane, N-(3′-trimethoxysilylpropyl)-piperazine, N-(3′-triethoxysilylpropyl)-piperazine, N-(3′-trimethoxysilylpropyl)morpholine, N-(3′-triethoxysilylpropyl)morpholine, bis(3-trimethoxysilylpropyl)amine, bis(3-triethoxysilylpropyl)amine, tris(3-trimethoxysilylpropyl)amine, tris(3-triethoxysilylpropyl)amine, N-methyl-N-butyl-3-aminopropyltrimethoxysilane, N-methyl-N-butyl-3-aminopropyltriethoxysilane, N-(3′-aminopropyl)-3-aminopropyltrimethoxysilane, N-(3′-aminopropyl)-3-aminopropyltriethoxysilane, N-phenyl-3-aminopropyltrimethoxy silane, N-phenyl-3-aminopropyltriethoxysilane, 3-mercaptopropyltrimethoxysilane, 3-mercaptopropyltriethoxysilane and derivatives bearing similar structures.

ii. Viscosity Modifier Compounds

The coating composition can include a viscosity modifier or a mixture of viscosity modifiers. The viscosity modifier can aid in achieving a desired viscosity for the coating composition or a solution of the coating composition. Non-limiting examples of viscosity modifiers can include an alkylsiloxane in oligomer/co-oligomer form, polymer/co-polymer form or a combination thereof having an average molecular weight between 100 to 100,000 Da and a general formula (VII):

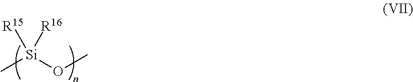

where R¹⁵ and R¹⁶ can be the same or different and are hydrogen, a substituted or unsubstituted alkyl or derivatives thereof.

Non-limiting examples of viscosity modifiers include 3-aminopropyl-terminated poly(dimethylsiloxane), chlorine-terminated poly(dimethylsiloxane), glycidyl ether-terminated poly(dimethylsiloxane), hydride-terminated poly(dimethylsiloxane), hydroxy-terminated poly(dimethylsiloxane), hydroxyalkyl-terminated poly(dimethylsiloxane), vinyl-terminated poly(dimethylsiloxane), trimethyl silyl-terminated poly(dimethylsiloxane) and derivatives bearing similar structures.

iii. Functional Additives

In some embodiments, one or more functional additives may be added to the coating composition. These additive do not impair or only have a slight effect the original functions of the coatings. The functional additives can have UV absorbing or blocking, antireflective, anti-abrasion, fire-retardant, conducting, antimicrobial, antibacterial, antifungal benefits or color imparting properties. The functional additives can includes organic/inorganic molecules/polymers having molecular weight up to about 100,000 Da, organic micro/nano materials in their natural or synthetic forms (e.g. particles, nanotubes and nanosheets) having sizes equal to or between about 2 nm to 500 μm, metal/metal oxide micro/nano materials (e.g., silver, titanium oxide, zinc oxide, aluminum oxide, iron oxide, selenium oxide, tellurium oxide and clay, which may be composed of kaolinite, montmorillonite, illite or chlorite) in their natural or synthetic forms (e.g., particles, nanotubes and nanosheets) having sizes equal to or between about 2 nm to 500 μm; and combinations thereof.

In some embodiments, one or more color imparting additives (e.g., pigments or dyes), which do not impair or only have a slight effect on the original functions of the materials, can be added to the coating composition. Such pigments may include materials that change the color of reflected or transmitted light as the result of wavelength-selective absorption. Non-limiting examples of such wavelengths include the range of wavelengths humans can or cannot perceive, such as visible light having wavelength from approximately 390 to 700 nm; ultraviolet light having wavelengths approximately 100 to 390 nm and infrared and lower energy radiation having wavelengths from approximately 700 nm to 1 mm. Non-limiting examples of pigments and dyes include metal-based inorganic pigments containing metal elements such as cadmium, chromium, cobalt, copper, iron oxide, lead, manganese, mercury, titanium tellurium, selenium and zinc; other inorganic pigments such as carbon, clay earth and ultramarine; organic pigments such as alizarin, alizarin crimson, gamboge, carmine, purpurin, indigo, Indian yellow, tyrian purple, quinacridone, magenta, phthalo green, phthalo blue, diarylide yellow, pigment red, pigment yellow, pigment green, pigment blue and other inorganic or organic derivatives thereof. In some embodiments, pigments also include materials that protect the host composite from degradation caused by exposure to ultraviolet radiation, such as ultraviolet light absorbers, e.g. 2-hydroxyphenyl-benzophenones, 2-(2-hydroxyphenyl)-benzotriazole and 2-hydroxyphenyl-s-triazines derivatives; hindered-amine light stabilizers, e.g., tetramethyl piperidine derivatives and antioxidants, e.g., sterically hindered phenols, phosphites and thioethers. In some embodiments, pigments also include materials that emit colors, such as through fluorescence, phosphorescence, and/or other forms of luminescence. Such pigments may include, but are not limited to, fluorophores, such as fluorescein, rhodamine, coumarin, cyanine and their derivatives; phosphorescent dyes such as zinc sulfide, Strontium aluminate and their derivatives.

### C. Process to Make the Coating Composition

In some embodiments, the coating composition is prepared by mixing at least one pesticide and a solvent, a base compound, a bonding agent, and a plasticizer, under acidic conditions (e.g., pH<5). Optional compounds that include one or more chelating agents, one or more viscosity modifiers, one or more functional additives and one or more color imparting compounds can be also be added to the mixture. In some embodiments, the coating composition can include 0.001 to 30 vol. %, 0.1 to 20 vol. %, 1 to 10 vol. % or 2 to 5 vol. % or any value there between of at least one pesticide, 10 to 40 vol. %, 20 to 35 vol. %, 15 to 30 vol. %, or 30 to 40 vol. % or any value there between of at least one solvent, 30 to 70 vol. %, 35 to 65 vol. %, or 40 to 60 vol. % or any value there between of at least one base compound, 10 to 20 vol. % of at least one plasticizer or any value there between, 1 to 10 vol. %, 5 to 10 vol. % or any value there between of at least one bonding compound. The amount of ingredients can depend inter alia on the desired property of the coating composition. In some embodiments, the coating composition can include at least one of the chelating agent(s), the viscosity modifier(s), the functional additive(s) and the pigment(s). The amount of optional ingredients can depend inter alia on the desired property of the coating composition. The mixture of the aforementioned compounds may be stirred at elevated temperature between 50 to 100° C., 55 to 80° C., or 60 to 70° C. for about 30 minutes, 1 hour, 10 hours, 24 hour, to 10 days. Without wishing to be bound by theory it is believed that the pesticides are either chemically reacted or physically entrapped/encapsulated with the materials used for the coating. In some embodiments, the coating composition is further diluted with more solvent(s) to a final concentration no less than 20 vol. % to form the final coating composition for material coatings. In some embodiments, the coating composition can at least partial hydrolyzed or completely hydrolyzed.

### D. Treatment of Substrates

Substrates that can be treated with the coating composition of the present invention can include wood, fabrics, masonry materials or aquatic structures or the like. The coating composition can also be applied to the soil as barrier treatment or incorporated into bait used to attract pests. In one embodiment, wood is treated to inhibit termite damage. In addition, the pesticide coating composition (composite material) can also be impregnated into textiles, masonry materials or aquatic structures, applied to the soil as barrier treatment or incorporated into baits. The present invention also pertains to material coatings, e.g. paint, stain, sealant, varnish and finish, made from such compositions.

1. Substrates

The substrate can include wood, textiles, masonry materials, aquatic structures, soil. Wood contains three major chemical constituents: cellulose; hemicellulose; and lignin. Wood can include the fibrous structural tissue found in the stems and roots of trees and other woody plants, or a composite or product containing or partially composed of these aforementioned fibrous structural tissues or chemical constituents. A textile can be any filament, fiber, or yarn that can be made into a fabric or cloth, and the term also includes the resulting fabric or cloth material itself. Non-limiting examples of textiles include natural fibers (protein or cellulosic) such as cotton, linen, wool, silk, leather synthetic fibers such as viscose, acrylic, nylon and polyester, semisynthetic fibers, synthetic leather, mineral-based fibers such as fiberglass, and any conceivable combinations of these materials or related microfibers, or composite or product containing or partially composed of these aforementioned fibrous structural materials. Masonry materials can include materials used in man-made structures, buildings, or the like. Non-limiting examples of masonry materials include brick, stone, marble, granite, travertine, limestone, cast stone, concrete block, stucco, tile, cob and concrete, cement, mortar and grout or other cementitious materials. Masonry materials can also include any hybrid or composite materials with additives or synthetic or natural fibers to increase certain properties such as strength, ductility, elasticity, viscosity, or the like. Aquatic structures can be any engineered object or system of objects designed to exist, operate, or function in an aquatic environment, including all varieties of freshwater, saltwater, and brackish water bodies either naturally occurring and/or man-made in origin. An aquatic environment in the context of the invention is the aquatic surroundings of any physical system that is in either direct or indirect contact with said system with which that system may interact with. Aquatic structures may be classified as either fixed, semi-fixed, or free-moving. Non-limiting examples of fixed aquatic structures include but are not limited to resource transportation infrastructure, structural/functional/aesthetic components of aquatic facilities, structural/functional/aesthetic components of bridges/piers/docks/jetties/reservoirs/dams/floodgates, and structural/functional/aesthetic components of aquaria. Non-limiting examples of semi-fixed aquatic structures include but are not limited to tethered buoys, trawling nets, aquatic cage traps, and anchoring systems. Non-limiting examples of free-moving aquatic structures include but are not limited to the exterior hulls of both surface-dwelling and submarine aquatic vessels.

2. Pre-Treatment of Substrate

In some embodiments, the target surface of substrates can be activated before the deposition of the coating composition of the present invention. The surface activation may be achieved by reaction with ozone, oxygen, hydrogen peroxide, halogens, other reactive oxidizing species, or combinations thereof. Without wishing to be bound by theory it is believed that the activation can create an energetically reactive surface, increase the concentration of free radicals and to bind molecules on the surface covalently. In some embodiments, the surface activation may be achieved by ozone plasma generated by intense UV light. In other embodiments, surface activation may be achieved by plasma treatment. In yet another embodiment, surface activation may be achieved by ozone generation using a corona discharge, flame, or plasma.

3. Treatment of Substrate with Coating Compositions of the Present Invention

The substrate can be treated with the coating composition using known coating techniques and as described in the Examples section. Application of the coating composition can be achieved by spraying, misting, doctor-blading, padding, foaming, rolling or inkjet printing, or the like. The coating composition can be mixed with a solvent to form a coating composition solution (e.g., for example a 20 vol. % of coating composition in a solvent described herein). In a non-limiting example, a coating composition solution can be applied to the soil as barrier treatment or incorporated into baits. In another non-limiting example, the substrate can be dipped into the coating composition solution for a set period of time equal to or between about 1 second and 24 hour. The solvent may then be removed from the substrate, and the substrate may be dried or cured at an average temperature from about 25 and 200° C., between 25 and 200° C., 30 to 150° C., 50 to 100° C., 60 to 90° C., or any range or temperature value there between. In certain embodiments, the crosslink density of the crosslinkable components, e.g., the degree of crosslinking can range from 1% to 100% of complete crosslinking. The treated substances can be substantially water repellent, and, thus, provide resistance against leaching of the pesticides from the substrates by water in exposed environment such as exterior applications.

4. Additional Coatings

In some embodiments, after the substrate is treated with the coating composition of the present invention, the resulting surface may also be treated with hydrophobic compounds and/or other chemical compounds, which renders the surface hydrophobic/superhydrophobic and also generates nanoscopic or microscopic topography. Non-limiting example of hydrophobic compounds used as coating can include a fluoroalkylsilane, an alkylsilane, an alkoxyfluoroalkylsilane, an alkoxyalkylsilane or any mixture thereof. The alkylsilane and/or alkoxyfluoroalkylsilane, alkoxyalkylsilane also be used alone or in conjunction with fluoroalkylsilane to perform similar tasks to render the surface hydrophobic and/or to generate nanoscopic topography. Without wishing to be bound by theory it is believed that the fluoroalkylsilane, the alkylsilane and/or the alkoxyfluoroalkylsilane covalently bond to the substrate surface, which renders the surface hydrophobic/superhydrophobic and also generates nanoscopic or microscopic topography. In some embodiments, the hydrophobic chemical agents and/or other chemical agents may be deposited utilizing a vapor treatment and/or in a controlled environment. In some embodiments, the hydrophobic compounds may be dissolved or dispersed in one or more organic solvents. Typically, the concentration of the hydrophobic compound in an organic solvent is between 0.1 and 15 vol. %. Non-limiting examples of organic solvents include toluene, benzene, xylene, trichloroethylene, 1,2-dichloroethane, dichloromethane, chloroform, carbon tetrachloride, tetrachloroethylene, n-propyl bromide, diethyl ether, acetone, diisopropyl ether, methyl-t-butyl ether, petroleum ethers and petroleum hydrocarbons.

5. Fluoroalkylsilane Compounds

In some embodiments, the hydrophobic chemical agents can be fluoroalkylsilane. Such fluoroalkylsilane compounds can have a general formula (VIII):

[CF₃(CF₂)ₐ(CH₂)_{b}]_{c}SiR¹⁷_{d}Xₑ, (VIII)
where X is Cl, Br, I, an organic leaving group, or any combination thereof;
R¹⁷ is a substituted or unsubstituted alkyl group, a substituted or unsubstituted alkenyl group, a substituted or unsubstituted alkynyl group, a substituted or unsubstituted aryl group or derivatives thereof; and
a is an integer form 0 to 20, b is an integer from 0 to 10, c, and e, are each independently an integer from 1 to 3, d is 0, 1, 2, 3 and the sum of c, d and e is 4.

Non-limiting examples of preferred fluoroalkylsilane compounds include trichloro(3,3,3-trifluoropropyl)silane, dichloro-methyl(3,3,3-trifluoropropyl)silane, chloro-dimethyl(3,3,3-trifluoropropyl)silane, trichloro(1H,1H,2H,2H-perfluorobutyl)silane, dichloro-methyl(1H,1H,2H,2H-perfluorobutyl)silane, chloro-dimethyl(1H,1H,2H,2H-perfluorobutyl)silane, trichloro(1H,1H,2H,2H-perfluorohexyl)silane, dichloro-methyl(1H,1H,2H,2H-perfluorohexyl)silane, chloro-dimethyl(1H,1H,2H,2H-perfluorohexyl)silane, trichloro(1H,1H,2H,2H-perfluorooctyl)silane, dichloro-methyl(1H,1H,2H,2H-perfluorooctyl)silane, chloro-dimethyl(1H,1H,2H,2H-perfluorooctyl)silane, trichloro(1H,1H,2H,2H-perfluorodecyl)silane, dichloro-methyl(1H,1H,2H,2H-perfluorodecyl)silane, chloro-dimethyl(1H,1H,2H,2H-perfluorodecyl)silane, trichloro(1H,1H,2H,2H-perfluorododecyl)silane, dichloro-methyl(1H,1H,2H,2H-perfluorododecyl)silane, chloro-dimethyl(1H,1H,2H,2H-perfluorododecyl)silane and derivatives bearing similar structures.

6. Alkylsilane Compounds

Alkylsilane compounds of the present invention include alklysilanes having the formula (IX):

[CH₃(CH₂)ₐ]_{b}SiR¹⁸_{c}X_{d}, (IX)
where X is Cl, Br, I or other suitable organic leaving groups;
R¹⁸ is a substituted or unsubstituted alkyl group, a substituted or unsubstituted alkenyl group, a substituted or unsubstituted alkynyl group, a substituted or unsubstituted aryl group or derivatives thereof; and
a is an integer from 0 to 20, b and d are each independently an integer from 1 to 3,
c is 0, 1, 2, 3 and the sum of b, c and d is 4.
   Non-limiting examples of alkylsilane compounds include chlorosilane, dichlorosilane, trichlorosilane, chlorotrimethylsilane, dichlorodimethylsilane, trichloromethylsilane, chlorophenylsilane, dichlorophenylsilane, trichlorophenylsilane, chloromethylphenylsilane, chlorodimethylphenylsilane, dichloromethylphenylsilane, chlorodimethylphenethylsilane, dichloromethylphenethylsilane, trichlorophenethylsilane, chlorodimethyloctylsilane, dichloromethyloctylsilane trichlorooctylsilane, chlorodimethyldodecylsilane, dichloromethyldodecylsilane, trichlorododecylsilane, chlorodecyldimethylsilane, dichlorodecylmethylsilane, trichlorodecylsilane, chlorodimethyloctadecylsilane, dichloromethyloctadecylsilane, trichlorooctadecylsilane, chlorodimethylthexylsilane, dichloromethylthexylsilane, trichlorothexylsilane, allyldichloromethylsilane, allylchlorodimethylsilane, allyltrichlorosilane, (cyclohexylmethyl)chlorodimethylsilane, (cyclohexylmethyl)dichloromethylsilane, (cyclohexylmethyl)trichlorosilane and derivatives bearing similar structures.

7. Alkoxyfluoroalkylsilane Compounds

Alkoxyfluoroalkylsilane compounds of the present invention include alkoxyfluoroalkylsilane having the general formula (XII):

[CF₃(CF₂)ₐ(CH₂)_{b}]_{c}SiR¹⁹_{d}[alkoxy]ₑ, (XII)
where alkoxy is methoxy, ethoxy, propoxy, isopropoxy, butoxy, isobutoxy, or a combination thereof;
R¹⁹ is a substituted or unsubstituted alkyl, a substituted or unsubstituted alkenyl, a substituted or unsubstituted alkynyl, a substituted or unsubstituted aryl or derivatives thereof; and
a is an integer from 0 to 20, b is an integer from 0 to 10, c and e are each independently an integer from 1 to 3, d is 1, 2, 3, and the sum of c, d and e is 4.
   Non-limiting examples of alkoxyfluoroalkylsilane compounds include trimethoxy(3,3,3-trifluoropropyl)silane, triethoxy(3,3,3-trifluoropropyl)silane, tripropoxy(3,3,3-trifluoropropyl)silane, triisopropoxy(3,3,3-trifluoropropyl)silane, trimethoxy(1H,1H,2H,2H-perfluorobutyl)silane, triethoxy(1H,1H,2H,2H-perfluorobutyl)silane, tripropoxy(1H,1H,2H,2H-perfluorobutyl)silane, triisopropoxy(1H,1H,2H,2H-perfluorobutyl)silane, trimethoxy(1H,1H,2H,2H-perfluorohexyl)silane, triethoxy(1H,1H,2H,2H-perfluorohexyl)silane, tripropoxy(1H,1H,2H,2H-perfluorohexyl)silane, triisopropoxy(1H,1H,2H,2H-perfluorohexyl)silane, trimethoxy(1H,1H,2H,2H-perfluorooctyl)silane, triethoxy(1H,1H,2H,2H-perfluorooctyl)silane, tripropoxy(1H,1H,2H,2H-perfluorooctyl)silane, triisopropoxy(1H,1H,2H,2H-perfluorooctyl)silane, trimethoxy(1H,1H,2H,2H-perfluorodecyl)silane, triethoxy(1H,1H,2H,2H-perfluorodecyl)silane, tripropoxy(1H,1H,2H,2H-perfluorodecyl)silane, triisopropoxy(1H,1H,2H,2H-perfluorodecyl)silane, trimethoxy(1H,1H,2H,2H-perfluorododecyl)silane, triethoxy(1H,1H,2H,2H-perfluorododecyl)silane, tripropoxy(1H,1H,2H,2H-perfluorododecyl)silane, triisopropoxy(1H,1H,2H,2H-perfluorododecyl)silane and derivatives bearing similar structures. In some embodiments, the hydrophobic chemical agent may be dissolved or dispersed in an organic solvent or a mixture of organic solvents. Typically, the concentration of the hydrophobic chemical agent(s) in organic solvent(s) is between 0.1 and 15 vol. %. The preferred organic solvents may include, but are not limited to, methanol, ethanol, n-propanol, isopropanol, n-butanol, isobutanol, acetone, acetonitrile, dioxane, tetrahydrofuran, tetrachloroethylene, n-propyl bromide, dimethylformamide, dimethyl sulfoxide and water.

In some embodiments, the alkoxyfluoroalkylsilane (formula XII) is chemically converted from the fluoroalkylsilane (e.g., formula VIII) by mixing and heating the fluoroalkylsilane in the correspondent solvent (e.g. methanol, ethanol, isopropanol and water). The mixture of the compounds is preferred to be stirred at elevated temperature between 50 to 100° C. for about 1 hour to 7 days in an acidic environment (pH<1) and the solutions were neutralized with KOH (may contain up to 15% (w/w) of water) until the pH reached between 6 and 8. The hydrophobic solutions were used directly or further diluted in an appropriate solvent (e.g., methanol, ethanol, isopropanol, denatured ethanol, water, etc.).

8. Alkoxyalkylsilane Compounds

Alkoxyalkylsilane compounds of the present invention can have the general alkoxyalkylsilane formula (XIII):

[CH₃(CH₂)ₐ]_{b}SiR²⁰_{c}[alkoxy]_{d}, (XIII)
where [alkoxy] is methoxy, ethoxy, propoxy, isopropoxy, butoxy, isobutoxy, or a combination thereof;
R²⁰ is a substituted or unsubstituted alkyl group, a substituted or unsubstituted alkenyl group, a substituted or unsubstituted alkynyl group, a substituted or unsubstituted aryl group, or derivatives thereof; and
a is an integer from 0 to 20, b and d are each independently integers from 1 to 3, c is an integer from 0 to 3, and the sum of b, c and d is 4.

Non-limiting examples of alkoxyalkylsilane compounds include trimethoxyisobutylsilane, triethoxyisobutylsilane, dimethoxydiisobutylsilane, diethoxydiisobutylsilane, trimethoxy(hexyl)silane, triethoxy(hexyl)silane, tripropoxy(hexyl)silane, triisopropoxy(hexyl)silane, trimethoxy(octyl)silane, triethoxy(octyl)silane, tripropoxy(octyl)silane, triisopropoxy(octyl)silane, trimethoxy(decyl)silane, triethoxy(decyl)silane, tripropoxy(decyl)silane, triisopropoxy(decyl)silane, trimethoxy(dodecyl)silane, triethoxy(dodecyl)silane, tripropoxy(dodecyl)silane, triisopropoxy(dodecyl)silane and derivatives bearing similar structures. In some embodiments, the hydrophobic chemical agent may be dissolved or dispersed in an organic solvent or a mixture of organic solvents. Typically, the concentration of the hydrophobic chemical agent(s) in organic solvent(s) is between 0.1 and 15 vol. %. The preferred organic solvents may include, but are not limited to, methanol, ethanol, n-propanol, isopropanol, n-butanol, isobutanol, acetone, acetonitrile, dioxane, tetrahydrofuran, tetrachloroethylene, n-propyl bromide, dimethylformamide, dimethyl sulfoxide and water. Other chemical agents may also be used alone or in conjunction with alkoxyalkylsilanes to perform similar tasks to render the surface hydrophobic and/or to generate nanoscopic topography.

In some embodiments, the alkoxyalkylsilane (e.g., formula XIII) is chemically converted from the alkylsilane (e.g., formula IX) by mixing and heating the alkoxyalkylsilane in the correspondent solvent(s) (e.g., methanol, ethanol, isopropanol and water). The mixture of the thereof chemical agents is preferred to be stirred at elevated temperature between 50 to 100° C. for about 1 hour to 7 days in an acidic environment (pH<1) and the solutions were neutralized with KOH (may contain up to 15% (w/w) of water) until the pH reached between 6 and 8. The hydrophobic solutions were used directly or further diluted in an appropriate solvent (e.g., methanol, ethanol, isopropanol, denatured ethanol, water, etc.).

9. Treatment of Coated Materials with Other Coating Compounds

In some embodiments, the coating substrates may be treated with the other hydrophobic compounds to increase the surface hydrophobicity of the resulting coated substrate. The coated substrates can be placed in an enclosed environment where the hydrophobic compounds are evaporated onto the articles by heating at the temperature between 25 and 200° C., 30 to 150° C., 50 to 100° C., 60 to 90° C., or any range or temperature value there between.

In some embodiments, the a solution of the hydrophobic compound may be deposited on the surface of coated wood materials by methods including, but not limited to, spraying, misting, doctor-blading, padding, foaming, rolling or inkjet printing. As another non-limiting example, the coated substrates may be dipped into the solution for a set period of time equal to or between about 1 second and about 24 hour. The solvent may then be removed from the coated substrates and the hydrophobic coated substrates containing the pesticide may be dried or cured at a set temperature equal to or between about 25 and about 200° C., between 25 and 200° C., 30 to 150° C., 50 to 100° C., 60 to 90° C., or any range or temperature value there between. In certain embodiments, the crosslink density of the crosslinkable components, e.g., the degree of crosslinking can range from 1% to 100% of complete crosslinking.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Preparation of Coating Composition

The following describes the preparation of the coating composition of the present invention. The coating composition was prepared by adding a pesticide (2.5 w/v % disodium octaborate tetrahydrate with respect to the total volume of the coating composition), a base compound (tetraethyl orthosilicate), a plasticizer compound (trimethoxypropylsilane), a bonding compound (3-glycidoxy-propyltrimethoxysilane) to a solvent (water and methanol) in various percentages described in the specification. The pH was adjusted (pH=5, adjusted with HCl), and the mixture was stirred at 50 to 60° C. for about 4 hours.

### Example 2

### Coating of Wood with Composition

The resulting mixture was used to treat five identical Southern Yellow Pine (SYP) panels (approximately 1″×1″×¼″) by soaking the panels with the coating composition for 30 minutes. The panels were fully cured in the oven at 60 to 80° C. before sending out for independent testing. The pesticide concentration imbedded in the Southern Yellow Pine panel was estimated to be around 0.25-0.50 w/w %.

### Example 3

### Testing of Composition

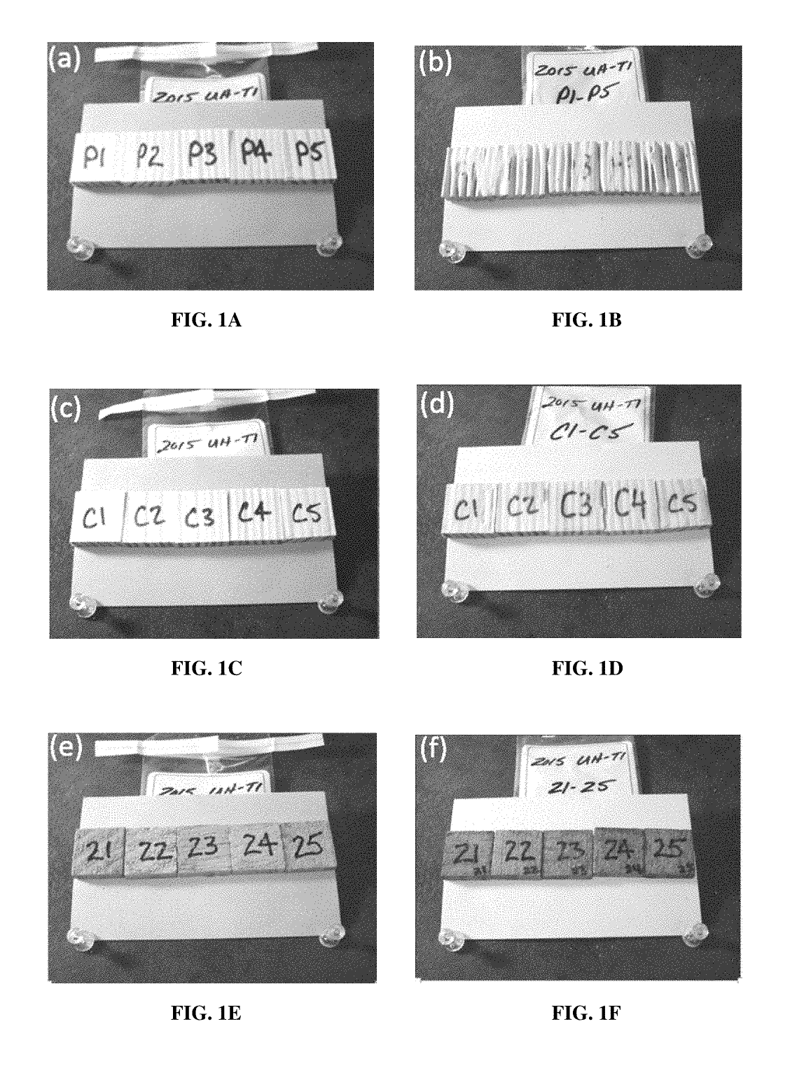

Laboratory evaluation of treated or untreated cellulosic material for its resistance to subterranean termites and the result was performed. Sample 1 was a SYP treated with the pesticide coating composition of the present invention. Comparative Sample 2 was a comparative preservative (ACQ) treated SYP samples with a preservative retention of approximately 0.25 pounds per cubic foot (pcf). Sample 1, Comparative Sample 2, and a pristine untreated sample were subjected to a Standard Method for Laboratory Evaluation to Determine Resistance to Subterranean Termites (AWPA E1-13, where AWPA stands for American Wood Protection Association). This procedure was useful for determining the toxicity of materials to termites, especially the threshold concentrations necessary for toxicity, and whether materials are sufficiently repellent to prevent termite feeding even when no other choices are available. Subterranean termites used in this test can be from the genera Reticulitermes, Coptotermes, or Heterotermes. Test results obtained with a particular termite species may be applicable to other species and genera as well, but this cannot be assumed to be the case. Reticulitermes flavipes were chosen as the termite to be tested against as Reticulitermes flavipes has a very broad geographic distribution in eastern North America. The termites from the colony used consisted of approximately 2% soldiers and the rest are workers. Five replicate samples were prepared for each preservative or chemical to be tested. Five untreated blocks were used as controls for each separate study. Each replicate container contained damp sand, termites, and a single test block. After exposure, the samples were visually rated for termite attack and defacement on a 0 to 10 rating scale by estimating the percentage of surface defacement with 10 being sample being sound with no defacement and 0 being sample failure being completely defaced (See, FIGS. 1A-1D). FIGS. 1A and 1B are the images of the pristine wood sample, FIGS. 1C and 1D are the images of the wood sample (Sample 1) coated with the coating composition of the present invention, FIGS. 1E and 1F are the images of the wood samples treated with comparative pesticide (Comparative Sample 2) before and after 4-week exposure to Reticulitermes flavipes. In addition to visual rating, each block was conditioned to a consistent mass which was recorded. The percentage change in dry mass i.e., weight loss due to termite activity was reported. The containers were also examined for termite mortality, with slight, moderate, heavy and complete corresponding to 0 to 33%, 34 to 66%, 67 to 99% and 100% completely. As shown at the Table 1, list the data summary for the samples following 4 weeks of exposure to Reticulitermes flavipes. As determined from the data, both samples 1 and 2 have very low weight loss, ˜0.9% and complete termite mortality demonstrating the coating composition of the present invention has the same degree of resistance to termites as the controlled ACQ treatment.

TABLE 1

| | | Avg. | Visual Block Rating (Mortality) | | | | |
|---|---|---|---|---|---|---|---|
| | Avg. | Visual | Sample # | | | | |
| Sample | % Wt. | Block | s = 0 to 33%; h = 67% to 99%; x= | | | | |
| Description | Loss | Rating | 1 | 2 | 3 | 4 | 5 |
| Pristine | 14.53 | 5 | s | s | s | s | s |
| Sample 1 | 0.95 | 9 | x | x | x | x | x |
| Comparative | 0.90 | 10 | h | h | x | x | x |
| Sample | | | | | | | |

1. A hydrophobic coating composition for treating of a substrate, the hydrophobic coating composition comprising:
(a) at least one active compound; and
(b) a sol-gel derived from at least one base compound, at least one bonding agent, and at least one plasticizer,
wherein the coating composition is hydrophobic, and
wherein the active compound is 1) capable of chemically reacting with the base compound, the at least one bonding agent, the at least one plasticizer, or any combination thereof, or 2) encapsulated within the sol-gel network.

2. (canceled)

3. The composition of claim 1, wherein the active compound comprises a pesticide capable of destroying pests, preferably a termite.

4. The composition of claim 3, wherein the pesticide comprises an algaecide, an antifouling agent, an antimicrobial, a biocide, a fungicide, a herbicide, an insecticide, a miticide, a molluscicide, a nematicide, a ovicide, a pheromone, a rodenticide or any combination thereof.

5. The composition of claim 4, wherein the pesticide comprises a boron compound, a quaternary ammonium salt, or both.

6. The composition of claim of claim 5, wherein the boron compound comprises an inorganic borate, an organic borate, or both, preferably, a metal borate, a borate mineral, a borate ester.

7. The composition of claim 6, wherein the sodium borate is disodium octaborate tetrahydrate, sodium tetraborate decahydrate, sodium tetraborate pentahydrate, sodium tetraborate, sodium metaborate, sodium pentaborate, and mixtures of any of the above, potassium borate, calcium borate, magnesium borate, borate silicate, aluminum silicate borate hydroxide, silicate borate hydroxide fluoride, hydroxide silicate borate, sodium silicate borate, calcium silicate borate, aluminum borate, iron borate, copper borate, zinc borate.

8. The composition of claim 6, wherein the borate ester has a general formula of:
CₐH_{b}BO₃, (I)
where a is an integer of 3 to 100, and b is an integer in the range of 9 to 300.

9. The composition of claim 5, wherein the quaternary ammonium salt comprises an alkoxysilyl quaternary ammonium compound.

10. (canceled)

11. The composition of claim 1, wherein each of the at least base compound, the at least one bonding agent, and the at least one plasticizer are an alkoxysilane compound, a metal oxide precursor, or both.

12. The composition of claim 11, wherein the base compound has a general formula of M(OR⁶)₄ where M is Si, Al, Ti, In, Sn or Zr; and R⁶ is a hydrogen, a substituted or unsubstituted alkyl group or a derivative thereof.

13. The composition of claim 12, wherein the base compound is tetraethyl orthosilicate (Si(OCH₂CH₃)₄).

14. The composition of claim 12, wherein the bonding compound has a general formula of:
M(OR⁷)ₓR⁸_{y}R⁹_{z},
where M is Si, Al, In, Sn or Ti;
R⁷ is a hydrogen, a substituted or unsubstituted alkyl group or derivatives thereof;
R⁸ is a hydrogen, a substituted or unsubstituted alkyl group or derivatives thereof;
R⁹ is a substituted or unsubstituted epoxy or glycidoxy group; and
x and z are each independently an integer from 1 to 3, y is an integer from 0 to 2, and the sum of x, y and z is 4.

15. The composition of claim 14, wherein the bonding agent is 3-glycidoxypropyltrimethoxysilane (Si(OCH₃)₃glycidoxy).

16. The composition of claim 15, wherein the plasticizer has the general formula of:
M(OR¹⁰)₄₋ₓR¹¹ₓ,
where M is Si, Al, In, Sn or Ti;
R¹⁰ is a hydrogen, a substituted or unsubstituted alkyl group or derivatives thereof; and
R¹¹ is a substituted or unsubstituted alkyl group, a substituted or unsubstituted alkenyl group, a substituted or unsubstituted alkynyl group, a substituted or unsubstituted aryl group or a derivative thereof; and
x is 1, 2 or 3.

17. (canceled)

18. The composition of claim 1, comprising a chelating agent, a viscosity modifier, or a functional additive.

19. The composition of claim 18, wherein the chelating agent is an alkoxysilane, metal oxide precursor, or both having the general formula of:
M(OR¹²)ₓR¹³_{y}R¹⁴_{z},
where M is Si, Al, In, Sn or Ti;
R¹² includes a hydrogen, a substituted or unsubstituted alkyl group or derivatives thereof;
R¹³ includes a hydrogen, a substituted or unsubstituted alkyl group or derivatives thereof;
R¹⁴ includes a substituted or unsubstituted alky or alkenyl group having from 3 to 20 carbon atoms or a substituted or unsubstituted amine (including primary, secondary and tertiary) or thiol; and
x and z are each independently an integer from 1 to 3, y is an integer from 0 to 2, and the sum of x, y and z is 4.

20. The composition of claim 19, wherein the chelating agent is an alkoxysilane oligomer having the general structure of: 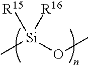
where R¹⁵ and R¹⁵ can be the same or different and are hydrogen, a substituted or unsubstituted alkyl or derivatives thereof.

21. (canceled)

22. (canceled)

23. The composition of any one of claim 1, wherein the coating composition does not include an amino-containing organoxysilane and an anhydride compound.

24. (canceled)

25. (canceled)

26. A method of making a coating composition of claim 1, the method comprising:
(b) obtaining at least one active ingredient, at least one base compound, at least one bonding agent, and at least one plasticizer;
(c) adding the at least one active ingredient, the at least one base compound, the at least one bonding agent, and the at least one plasticizer to a solvent to form a mixture; and
(d) mixing the mixture under acidic conditions to form a sol or sol-gel.

27-30. (canceled)

31. A method of coating a substrate in need of a coating or imparting pest and water resistance properties to the substrate, the method comprising:
(e) obtaining a substrate; and
(f) applying to the substrate the coating composition of claim 1, wherein the coating composition imparts pest and water resistance properties to the substrate.

32-45. (canceled)
